(19) United States
(12) Patent Application Publication
(10) Pub. No.: US 2025/0363571 A1
(43) Pub. Date: Nov. 27, 2025

(54) FIRST NODE AND METHODS PERFORMED THEREBY FOR DETERMINING A SOURCE OF POWER

(71) Applicant: Telefonaktiebolaget LM Ericsson (publ), Stockholm (SE)

(72) Inventors: Arpit SISODIA, Noida Uttar Pradesh (IN); Ravi Teja GANDHAM, Bengaluru (IN); Subhadip BANDYOPADHYAY, Bangalore (IN); Sunil Kumar VUPPALA, Bangalore (IN); Akshat VIKRAM, Bengaluru, Karnataka (IN); Heeresh SHARMA, Gurgaon (IN); Shishir SAINI, Punjab (IN)

(73) Assignee: Telefonaktiebolaget LM Ericsson (publ), Stockholm (SE)

(21) Appl. No.: 18/865,127

(22) PCT Filed: May 13, 2022
(86) PCT No.: PCT/IN2022/050465

§ 371 Date: Nov. 12, 2024

(51) Int. Cl. G06Q 50/06; H02J 3/00

(52) U.S. Cl. CPC G06Q 50/06; H02J 3/003; H02J 2203/20; H02J 2310/62

(57) ABSTRACT

A computer-implemented method, performed by a first node (101). The method is for determining a source of power. The first node (111) operates in a communications system (100). The first node (111) obtains (301) information about a first passive equipment power source (121), a second passive equipment power source (122) and an active power source (123) of a network node (110). The first node (111) then determines (302), using machine learning and the obtained information, a source of power to be used by the network node (110) at a future time period, out of the first passive equipment power source (121) and the second passive equipment power source (122). The determining (306) is based on an estimated cost of the power, and an estimated load at the power source during the time period. The first node (111) also provides (306) a first indication indicating the determined source of power to at least one of the network node (110) and a second node (102) operating in the communications system (100).

### TECHNICAL FIELD

The present disclosure relates generally to a first node and methods performed thereby for determining a source of power. The present disclosure further relates generally to a computer program and computer-readable storage medium, having stored thereon the computer program to carry out this method.

### BACKGROUND

Computer systems in a communications network may comprise one or more network nodes. A node may comprise one or more processors which, together with computer program code may perform different functions and actions, a memory, a receiving port and a sending port. A node may be, for example, a server. Nodes may perform their functions entirely on the cloud.

The communications network may cover a geographical area which may be divided into cell areas, each cell area being served by another type of node, a network node in the Radio Access Network (RAN), radio network node or Transmission Point (TP), for example, an access node such as a Base Station (BS), e.g. a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

User Equipments (UEs) within the communications network may be e.g., wireless devices, stations (STAs), mobile terminals, wireless terminals, terminals, and/or Mobile Stations (MS). UEs may be understood to be enabled to communicate wirelessly in a cellular communications network or wireless communication network, sometimes also referred to as a cellular radio system, cellular system, or cellular network. The communication may be performed e.g., between two UEs, between a wireless device and a regular telephone and/or between a wireless device and a server via a Radio Access Network (RAN) and possibly one or more core networks, comprised within the wireless communications network. UEs may further be referred to as mobile telephones, cellular telephones, laptops, or tablets with wireless capability, just to mention some further examples. The UEs in the present context may be, for example, portable, pocket-storable, hand-held, computer-comprised, or vehicle-mounted mobile devices, enabled to communicate voice and/or data, via the RAN, with another entity, such as another terminal or a server.

For many operators of communications networks, energy consumption has historically been a significant consideration, as it is one of the highest operating costs, where it may constitute between 20%-40% of a network's operational expenditure (OPEX).

Electrical power consuming equipment in a site may be broadly divided as passive and active. Active equipment may be understood as elements or components on the active layer of a telecommunications network, including, but not limited to, antennas, switches, servers, databases, radio access nodes, and transmission equipment. Passive Equipment, or Passive infra-asset, may be understood to refer to equipment which may be understood to not be comprised in the active equipment at a site. Examples of passive equipment may be a Diesel Generator (DG), Heating, Ventilating, AC/Refrigeration (HVAC) equipment, a battery, a rectifier, etc.

Today, according to research by TechRadar, operators are estimated to be spending over 25 billion USD a year to power their networks, and bases stations are consuming a high proportion of that budget. According to figures from one of the operators, base stations account for almost 60% of the total power consumption of a mobile network, while 20% is consumed by mobile switching equipment and around 15% by the core infrastructure.

In addition to financial costs, high power consumption has the side effect of resulting in Carbon Dioxide (CO2) emissions. Given the negative impact on the environment, some operators have stated their ambition of saving CO2 emissions above 50%.

Optimization of energy usage is a long-standing opportunity which may be understood to bring value to service providers of equipment manufacturers, but also to the managed services companies, which may create a win-win ecosystem for all the stakeholders.

Optimization of energy usage has been addressed from multiple facets in the general power source utilization aspect. For example, there are power switching related methods, based on voltage data [1,3] and power switching between Alternate Current (AC) sources [5]. In [2], a sensor collected data-based control system for power source switching is considered also. Some existing methods address optimization of energy usage problem from a rule-based solution perspective [4, 5].

Existing methods, as reviewed in [7] may also be found in the general energy management arena, mainly from a micro-grid-based energy management approach [7-9]. As discussed in [7], the mainstream works may be divided mainly in three sectors, namely optimization, forecasting and back-casting. In [9], battery aging and depth of discharge has been considered with the objective to propose optimal battery size to satisfy reliable and economical energy supply in a multi-type of distributed energy supply system.

Data volumes in mobile networks are increasing at an unprecedented rate. This rapid surge in data traffic has an impact on the energy consumption and carbon footprint of mobile networks, also raising a significant cost concern for communications service providers and their consumers. In a communications network, power may be consumed by different Radio Access Network (RAN) and microwave equipment, and products such as Multiple Input Multiple Output (MIMO), RAN compute Baseband Unit (BBU), Remote Radio Head (RRU) etc.

Optimization of energy usage has not been addressed in the context to any telecommunications application [1-10] involving passive equipment, or passive infra-asset, with some exceptions, such methods an application of deciding to put a cell into sleep mode is discussed in [5]. Existing methods to optimize energy usage in the telecommunications are generally drawn to active saving measures, such as shut down of radio technologies during low-peak traffic using AI-ML predictions based on traffic load. Here, the features assessed may comprise call attempts, Physical Resource Block (PRB) utilization, alarms, voice and data traffic. Such active saving measures may be understood to require energy savings by triggering temporary pauses of service, such as setting cells to sleep, which may negatively affect the provision of service to some users.

### SUMMARY

As part of the development of embodiments herein, one or more challenges with the existing technology will first be identified and discussed.

For telecommunication sites there may be understood to be a high dependency on grid and diesel generator availability, where most of the energy consumption may happen. In general, grid, genset, battery and other power sources are not being utilized optimally. For example, automatically controlled Diesel Generators may have a functionality to go on when the electrical grid may turn off due to an outage. Available battery capacity in such cases is not utilized efficiently as battery is being seen as the last solution for preventing outage. A suitable alternative that facilitate judicious usage of battery may reduce operational cost, as battery may be understood to be usually cheaper than DG and may also patron the green energy commitment. However, most of the time the energy stored in the battery may remain unused under the default power source switching auto mode. No intelligent solution may be found in existing methods to utilize existing battery capacity or available alternative energy sources unless a site controller is present. Even if a site controller is present, the site controller may always prioritize the electrical grid over the diesel generator and over available battery capacity. This is a static and basic configuration which may be understood to be safe to implement, but it does not ensure optimal power usage.

According to the foregoing, in existing methods, a large amount of energy is wasted and a high carbon footprint is created as a consequence due to the suboptimal utilization of power sources.

According to the foregoing, it is an object of embodiments herein to improve the determination of a source of power.

According to a first aspect of embodiments herein, the object is achieved by a computer-implemented method, performed by a first node. The method is for determining a source of power. The first node operates in a communications system. The first node obtains information about a first passive equipment power source, a second passive equipment power source and an active power source of a network node. The first node determines, using machine learning and the obtained information, a source of power to be used by the network node at a future time period. The first node determines the source of power to be used, out of the first passive equipment power source and the second passive equipment power source. The determining is based on an estimated cost of the power, and an estimated load at the power source during the time period. The first node then provides a first indication indicating the determined source of power to at least one of the network node and a second node operating in the communications system.

According to a second aspect of embodiments herein, the object is achieved by the first node, for determining the source of power. The first node is configured to operate in the communications system. The first node is further configured to obtain the information about the first passive equipment power source, the second passive equipment power source and the active power source of the network node. The first node is also configured to determine, using machine learning and the information configured to be obtained, the source of power to be used by the network node at the future time period, out of the first passive equipment power source and the second passive equipment power source. The determining is configured to be based on the estimated cost of the power, and the estimated load at the power source during the time period. The first node is further configured to provide the first indication configured to indicate the source of power configured to be determined to at least one of the network node and the second node configured to operate in the communications system.

According to a third aspect of embodiments herein, the object is achieved by a computer program, comprising instructions which, when executed on at least one processor, cause the at least one processor to carry out the method performed by the first node.

According to a fourth aspect of embodiments herein, the object is achieved by a computer-readable storage medium, having stored thereon the computer program, comprising instructions which, when executed on at least one processor, cause the at least one processor to carry out the method performed by the first node.

By obtaining the information, the first node may be enabled to process the data and then route the processed data to an analytics engine, where subsequent automated processes, such as the training of a machine-learning predictive model, may be applied to optimize energy supply related to the passive equipment.

By the first node determining the source of power to be used by the network node at the future time period based on the estimated cost of the power, and the estimated load at the power source during the time period, the first node may be enabled to, utilizing network data, identify the optimal energy source for the future time period for energy optimization, and churn out a recommendation accordingly, e.g., on a real time basis. This may enable a passive equipment power consumption saving via optimal recommendation, which may be understood to translate into significant cost savings. Passive equipment based energy cost saving may be derived from a combination of savings in daily consumption of fuel, electricity cost, e.g., savings from DG and grid usage. For example, the first node may be enabled to forecast low network activity, and hence recommend to use a source with low cost such as a low load bearing source e.g., a battery. Accordingly, a large amount of energy and a high carbon footprint may be enabled to be saved, since DG may not always be used, in a fixed manner, as a first choice for source of power, in case of outage of the active power source.

The first node may further enable a cost minimization of the visits to the site related to passive infrastructure, for example, because of the optimal DG usage and hence the less frequent refuelling requirement.

By sending the first indication to the network node, the first node may enable the network node to choose the most optimal power source, or most optimal combination of power sources, from the first passive equipment power source and the second passive equipment power source, e.g., battery and DG, when the active power source, e.g., the grid, may not be available due to power outage.

By sending the first indication to the second node, the first node may also initiate trouble tickets and actionable work orders and may recommend actions for improving energy efficiency of the site, site visit optimization, network performance and total cost of ownership. The second node may be enabled to then initiate an action to handle the recommendation.

Accordingly, embodiments herein may be understood to enable an improvement in the availability of the communications system, and in turn may advantageously enable a reduction in the load of the operations.

Based on all of the foregoing advantages, the performance of the communications system may thereby be enabled to be improved.

### BRIEF DESCRIPTION OF THE DRAWINGS

Examples of embodiments herein are described in more detail with reference to the accompanying drawings, according to the following description.

FIG. 1 is a schematic diagram illustrating energy costs associated to a site of a network node, according to existing methods.

FIG. 2 is a schematic diagram illustrating a non-limiting example of a communications system, according to embodiments herein.

FIG. 3 is a flowchart depicting embodiments of a method in a first node, according to embodiments herein.

FIG. 4 is graphical representation of an example of a site for the network node, according to embodiments herein.

FIG. 5 is a schematic diagram illustrating a non-limiting example of the determining of the first cost of power of the determined first load, according to embodiments herein.

FIG. 6 is a schematic diagram illustrating a non-limiting example of the determining of the second cost of power of the determined first load, according to embodiments herein.

FIG. 7 is a schematic diagram illustrating a non-limiting example of the estimation of the cost of the power of the first passive equipment power source 121 at a future time period, according to embodiments herein.

FIG. 8 is a schematic diagram illustrating a non-limiting example of the estimation of the cost of the power of the second passive equipment power source 122 at the future time period, according to embodiments herein.

FIG. 9 is a schematic diagram depicting a non-limiting example of a method performed by a first node, according to embodiments herein.

FIG. 10 is a schematic diagram depicting another non-limiting example of a method performed by a first node, according to embodiments herein.

FIG. 11 is a schematic block diagram illustrating two non-limiting examples, a) and b), of a first node, according to embodiments herein.

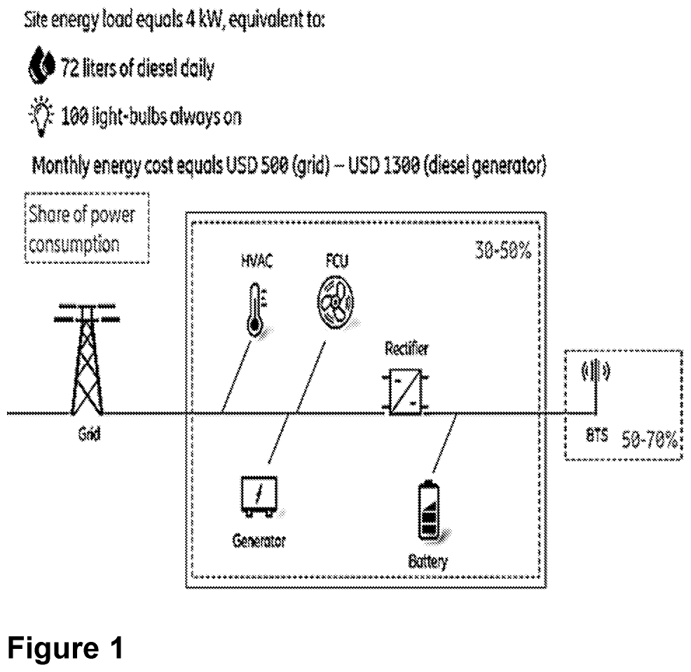

### DETAILED DESCRIPTION

Certain aspects of the present disclosure and their embodiments address the challenges identified in the Background and Summary sections with the existing methods and provide solutions to the challenges discussed.

Embodiments herein may be understood to relate to a method and a system to provide a recommendation of an optimal power source from available alternative power sources, namely battery and DG, in the absence of the default and least expensive power source, which may be an electric grid. The recommendation may be provided continually.

Particular embodiments herein may relate to a method for providing an Artificial Intelligence (AI)-based recommendation for optimal power source utilization for a site with an active power source, e.g., an electric grid, and support for two different passive equipment power sources, e.g., DG and battery. AI-powered methods may help service providers, according to embodiments herein, to break the energy curve while meeting rising data traffic demands.

As a summarized overview, embodiments herein may relate to a method that may comprise the following actions. First, a detailed data pre-processing pipeline may be performed, wherein data inconsistency mitigation and aggregation and merging of data coming from multiple sources at different time granularity may be executed. Then, features may be created from the data available within the processed data outputted by the data pipeline, which may comprise data from two different passive equipment power sources, e.g., battery and DG data. Next, temperature and load of the two different passive equipment power sources, e.g., of DG, and battery, may be forecasted with a prediction model. A Machine Learning (ML) model may then be built for the prediction of temperature and load at a first passive equipment power source, e.g., DG, utilizing the temperature prediction model as one of the inputs, and the load at a second passive equipment power source, e.g., battery, for a future time period, e.g., the immediate next 8 time points, for example, at 15 min intervals, for a given current time point. Using these forecasts, a cumulative cost for the two different passive equipment power sources, e.g., DG and battery, may be forecasted for the future time period, e.g., the immediate next 8 time points at 15 min intervals, for a given current time point. The cumulative costs of the sources may be then compared to identify the intervals and corresponding least expensive source, and a recommendation for an optimal power source recommend may be provided. This recommendation may be continued for each newly incoming set of data, and the previous recommendations may be overridden by the most recent one.

The embodiments will now be described more fully hereinafter with reference to the Accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

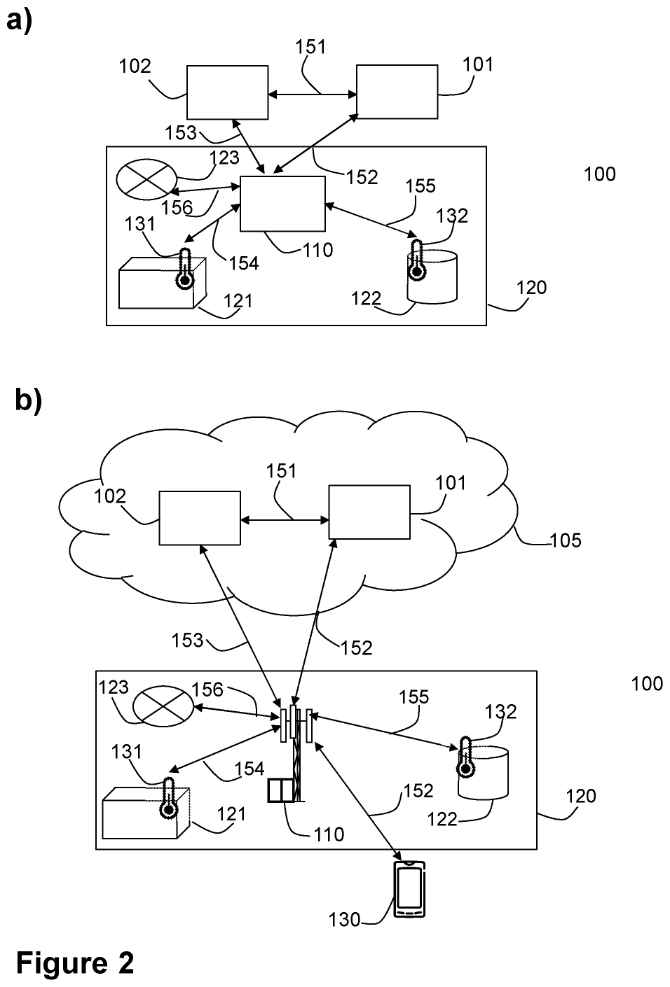

FIG. 2 depicts two non-limiting examples, in panels “a” and “b”, respectively, of a communications system 100, in which embodiments herein may be implemented. In some example implementations, such as that depicted in the non-limiting example of FIG. 2a, the communications system 100 may be a computer network. In other example implementations, such as that depicted in the non-limiting example of FIG. 2b, the communications system 100 may be implemented in a telecommunications system, sometimes also referred to as a telecommunications network, cellular radio system, cellular network or wireless communications system. In some examples, the telecommunications system may comprise network nodes which may serve receiving nodes, such as wireless devices, with serving beams.

In some examples, the telecommunications system may for example be a network such as 5G system, or a newer system supporting similar functionality. The telecommunications system may also alternatively or additionally support other technologies, such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3^{rd} Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as Ipv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 may comprise a plurality of nodes, whereof a first node 101, and a second node 102 are depicted in FIG. 2. Any of the first node 101 and the second node 102 may be understood, respectively, as a first computer system and a second computer system. In some examples, any of the first node 101 and the second node 102 may be implemented as a standalone server in e.g., a host computer in the cloud 105, as depicted in the non-limiting example depicted in panel b) of FIG. 2. Any of the first node 101 and the second node 102 may in some examples be a distributed node or distributed server, with some of their respective functions being implemented locally, e.g., by a client manager, and some of its functions implemented in the cloud 105, by e.g., a server manager. Yet in other examples, any of the first node 101 and the second node 102 may also be implemented as processing resources in a server farm.

In some embodiments, any of the first node 101 and the second node 102 may be independent and separated nodes. In some embodiments, the first node 101 and the second node 102 may be one of: co-localized and the same node. All the possible combinations are not depicted in FIG. 2 to simplify the Figure.

It may be understood that the communications system 100 may comprise more nodes than those represented on panel a) of FIG. 2.

In some examples of embodiments herein, the first node 101 may be understood as a node having a capability to train a predictive model using machine learning in the communications system 100. A non-limiting example of the first node 101 may be, e.g., in embodiments wherein the communications system 100 may be a 5G network, a Network Data Analytics Function (NWDAF), or e.g., a the central unit (CU) and a distributed unit (DU) of a radio network node.

The second node 102 may be a node having a capability to receive an indication from the first node 101. In some examples, the second node 102 may further have the capability to initiate a process to change, adjust or select a source of power to be used by a network node, based on a recommendation provided by the first node 101. In particular examples, the second node 102 may be e.g., a Radio Unit (RU), a CU and a DU of another a radio network node.

The communications system 100 may comprise one or more network nodes, whereof a network node 110 is depicted in FIG. 2. The network node 110 may typically be a radio network node, also referred to as a base station or Transmission Point (TP), or any other network unit capable to serve a wireless device or a machine type node in the communications system 100. The network node 110 may be e.g., a 5G gNB, a 4G eNB, or a radio network node in an alternative 5G radio access technology, e.g., fixed or WiFi. The network node 110 may be e.g., a Wide Area Base Station, Medium Range Base Station, Local Area Base Station and Home Base Station, based on transmission power and thereby also coverage size. The network node 110 may be a stationary relay node or a mobile relay node. The network node 110 may support one or several communication technologies, and its name may depend on the technology and terminology used. The network node 110 may be directly connected to one or more networks and/or one or more core networks.

The communications system 100 may cover a geographical area, which in some embodiments may be divided into cell areas, wherein each cell area may be served by a radio network node, although, one radio network node may serve one or several cells. In the example of FIG. 2, cells are not depicted to simplify the figure. The network node 110 may be of different classes, such as, e.g., macro eNodeB, home eNodeB or pico base station, based on transmission power and thereby also cell size. In some examples, the network node 110 may serve receiving nodes with serving beams. The network node 110 may support one or several communication technologies, and its name may depend on the technology and terminology used. The network node 110 that may be comprised in the communications network 100 may be directly connected to one or more core networks.

The network node 110 may be located at a site 120. The site 120 may be understood as, but not limited to, a combination of passive and active infrastructure on the ground, comprising radio equipment and supportive non-radio equipment serving for a geographical area in the communications network 100. Located at the site may be a first passive equipment power source 121, a second passive equipment power source 122 and an active power source 123. The first passive equipment power source 121 may be, for example, a diesel generator and the second passive equipment power source 122 may be, e.g., a battery. The active power source 123 may be an electrical grid. Any of the first passive equipment power source 121, the second passive equipment power source 122 and the active power source 123 may be capable of providing power to the network node 110 for operation. The e.g., wired connections between the first passive equipment power source 121, the second passive equipment power source 122 and the active power source 123 and the network node 110, or among each other, are not depicted in FIG. 2 to simplify the figure.

The communications system 100 may comprise a plurality of devices whereof a device 130 is depicted in panel b) of FIG. 2 as a UE located outside of the boundaries of the site 120. The device 130 may be also known as e.g., user equipment (UE), a wireless device, mobile terminal, wireless terminal and/or mobile station, mobile telephone, cellular telephone, or laptop with wireless capability, or a Customer Premises Equipment (CPE), just to mention some further examples. The device 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet computer, sometimes referred to as a tablet with wireless capability, or simply tablet, a Machine-to-Machine (M2M) device, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. The communication may be performed e.g., via a RAN and possibly one or more core networks, comprised, respectively, within the communications system 100. Another example of the device 130 may be a sensor, such as one or more first sensors 131, e.g., temperature sensors, that may be located on or near the first passive equipment power source 121, and one or more second sensors 132, e.g., other temperature sensors, that may be located or near the second passive equipment power source 122. The device 130 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server.

The first node 101 may communicate with the second node 102 over a first link 151, e.g., a radio link or a wired link. The first node 101 may communicate with the network node 110 over a second link 152, e.g., a radio link or a wired link. The network node 110 may communicate, directly or indirectly, with the second node 102 over a third link 153, e.g., a radio link or a wired link. The network node 110 may communicate, directly or indirectly, with the one or more first sensors 131 over a respective fourth link 154, e.g., a radio link or a wired link. The network node 110 may communicate, directly or indirectly, with the one or more second sensors 132 over a respective fifth link 155, e.g., a radio link or a wired link. The network node 110 may communicate, directly or indirectly, with the active power source 123, e.g., one or more sensors connected to the active power source 123, over a sixth link 156, e.g., a radio link or a wired link. Any of the first link 151, the second link 152, the third link 153, the respective fourth link 154 and/or the respective fifth link 155 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 2.

In general, the usage of “first”, “second”, “third”, “fourth”, “fifth” and/or “sixth” herein may be understood to be an arbitrary way to denote different elements or entities, and may be understood to not confer a cumulative or chronological character to the nouns these adjectives modify.

Although terminology from Long Term Evolution (LTE)/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

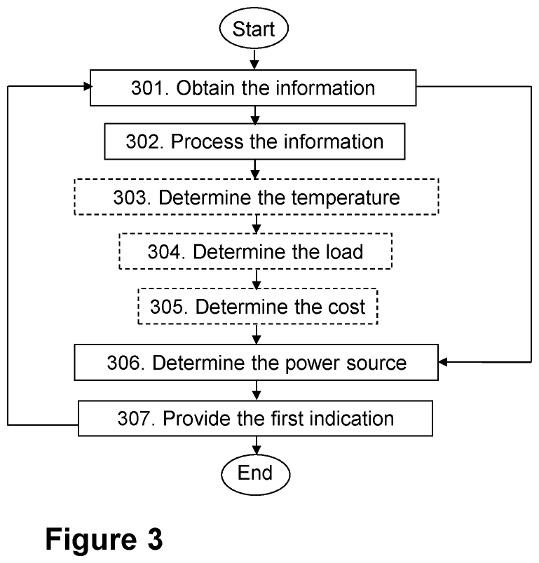

Embodiments of a computer-implemented method, performed by the first node 101, will now be described with reference to the flowchart depicted in FIG. 3. The method may be understood to be for determining a source of power. The first node 101 operates in the communications system 100.

The method may comprise the actions described below. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first node 101 is depicted in FIG. 3. In FIG. 3, optional actions in some embodiments may be represented with dashed lines.

In some embodiments, the method may be performed in real time.

### Action 301

In this Action 301, the first node 101 obtains information about the first passive equipment power source 121, the second passive equipment power source 122 and the active power source 123 of the network node 110.

The obtaining in this Action 301 may comprise, retrieving, collecting, measuring or receiving directly, or indirectly. In other words, in this Action 301, the first node 101 may receive the information originated at the first passive equipment power source 121, originated at the second passive equipment power source 122 and originated at the active power source 123, of the network node 110, wherein the receiving may be directly from the sources, or via another one or more nodes, e.g., via the network node 110.

The first passive equipment power source 121 may be a DG and the second passive equipment power source 122 may be a battery. As stated earlier, the active power source 123 may be the electrical grid.

In some examples, the information may comprise data, e.g., performance data, collected from four different sources, comprising the site 120, the first passive equipment power source 121, e.g., the DG, the second passive equipment power source 122, e.g., the battery, and the active power source 123, e.g., the electrical grid, via sensors. The information may be obtained in an asynchronous way.

To enable measurement and control in telecommunication sites such as the site 120, sensors and site controllers may be deployed at sites, e.g., the site 120, to make passive equipment visible, measurable, and controllable. The obtained information may accordingly comprise sensor data from the passive equipment at the site 120. Particularly, in some embodiments, the obtained information in Action 301 may comprise first information on a respective temperature at the first passive equipment power source 121 and the second passive equipment power source 122. The first information on the respective temperature may be obtained from the one or more first sensors 131 and the one or more second sensors 132, respectively.

In some embodiments, the obtained information in Action 301 may comprise second information on energy consumption at the network node 110.

The obtained information may comprise data on key performance indicators (KPIs) of the network node 110.

The obtaining of the information may be online, as streaming data coming out of the sensors and other multiple sources from the site 120. From the site 120, there may be also static type of data available such as battery type, battery life, information about DG model etc.

By obtaining the information in this Action 301, such as the data from the one or more first sensors 131 and the one or more second sensors 132 and site controllers, the first node 101 may be enabled to process the data in the next action and then route the processed data to an analytics engine in the first node 101, where subsequent automated processes, such as the training of a machine-learning predictive model, may be applied to optimize energy supply related to the passive equipment in the site 210, and thereby enable realization of savings of energy and reduction carbon footprint, e.g., in real time. The performance of the communications system 100 may thereby be enabled to be improved.

### Action 302

In this Action 302, the first node 101 may process the obtained information. Processing may be understood as performing further calculations. The first node 101 may process the obtained information to: a) synchronize data from the first passive equipment power source 121, the second passive equipment power source 122, and the active power source 123 of the network node 110, and the site 120 where the network node 110 is located, b) merge the synchronized data at a configured granularity to create a single source of data, and c) fill in missing data with an average value corresponding to a time stamp of a missing value for the site 120 where the network node 110 is located.

Since the information may be obtained in an asynchronous way, the processing in this Action 302 may comprise synchronizing data from the four sources named earlier using domain knowledge based logic. This may be performed, for example, in a window of 15 minutes.

By synchronizing the data in this Action 302, the first node 101 may enable that data, that may come from different sources non-uniformly over time may be synchronized at a common time granularity and hence, help forming features, e.g., from DG and battery.

The data may then be summarized appropriately and merged with a certain time granularity, for example, merged at a 15 min time granularity, and a single source of data may be created for further consumption. The data may be in a row-column format, where rows may be understood to be the sample, and columns may be understood to be different type of attributes, e.g., basic features. There may be a time column. Each row may be time stamped, that is, for each row there may be a value in the time column that may indicate when that row may be generated. When multiple such rows may be synchronized from multiple files that may be created in a common time interval, the first node 101 may reduce multiple time stamped rows into a single row having a single time stamp representing that interval. This reduction from multiple row to a single one may be usually referred to as summarization. To do that, different columns may be treated differently, e.g., for some column, the sum of the rows in that interval may be taken, for some column, the max value may be taken etc.

Since the data received, e.g., online, may have data missing at the site 120, the processing in this Action 302 may comprise a missing data filling process for the site 120, where the average observation from the site 120, of a column, that is, of an attribute, corresponding to the time stamp of the empty data over a certain time period, e.g., day or month, e.g., based on context, may be used to fill the gap that the site 120 may have. For example, if data corresponding to the site 120 with time stamp “1^{st} July, Monday, 10:15 am” is missing, the first node 101 may replace it, for each column of the data that the first node 101 may get from the site 120, e.g., corresponding to a basic feature, by the average of all the available data points of the same column corresponding to same month of the year, day of the week, hour of the day and minute of the hour for the site 120, that is, all available data points corresponding to Monday, 10.15 am from the month of July.

During the data processing and merging steps, domain knowledge-based logic may be applied to address several inconsistency and missing data filling. To mention a few, handling of sporadic discharge observation in the second passive equipment power source 122, e.g., the battery, filling of missing data from the active power source 123, e.g., electric current data, based on historical DG load, and filling of missing current and State of charge (SOC) data points based on historical SOC cycle etc. SOC may be understood as the electrical charge that may be present in a battery to serve as power source to run any equipment.

By filling in the missing data in this Action 302, the first node 101 may enable to mitigate data inconsistency, so that, ultimately, the determination of which source of power may be recommended to the network node 110 may be calculated accurately.

The synchronized and merged complete data may be understood to generate a data pipeline to create aggregated and merged data for the site 120 from streaming data coming out of the sensors named earlier and other multiple sources from the site 120s.

By processing the data in this Action 302, the first node 101 may aggregate the data and be enabled to route the processed data to an analytics engine, where subsequent automated processes may be applied. Merging may be understood to make it possible to match data from different sources at time level, and hence help forming features, e.g., from DG and battery. The synchronized and merged complete data may then be used for feature creation, training of Artificial Intelligence (AI)/Machine Learning (ML) model(s), and real time recommendation generation in order to optimise energy supply related to the passive equipment in the site 210, and thereby enable realization of savings, e.g., in real time.

### Action 303

In this Action 303, the first node 101 may determine, using the obtained first information, a first temperature at the first passive equipment power source 121 at a future time period and a second temperature at the second passive equipment power source 122 at the future time period. This Action 303 may be performed in embodiments wherein the obtained information in Action 301 may comprise the first information on the respective temperature at the first passive equipment power source 121 and the second passive equipment power source 122.

The determining in this Action 303 may comprise calculating, estimating, predicting, deriving or similar.

The determining in this Action 303 may be performed using an ML approach to predict temperature, or otherwise as well, e.g., by traditional time series modelling.

While the determination of the first temperature and the second temperature may be done separately, in typical examples, the first temperature and the second temperature may be the same, that is they may be determined as a single temperature, e.g., the temperature at the site 120, e.g., a shelter temperature. The shelter may be understood to be a place where the different equipment, such as air conditioning, battery and switch boxes may be kept. In a particular example wherein the first temperature may be the same as the second temperature, the determining in this Action 303 may comprise predicting the temperature for the next 8 time points, where the time unit may be taken as 15 min. That is, the first node 101 may predict the temperature for 8 consecutive 15 min immediate future time intervals. To do so, the first node 101 may predict, for each current time point and the site 120, the next time point temperature, and hierarchically continue to predict the temperature corresponding to the 8 time points by considering each predicted temperature as the lag one temperature input to predict the temperature in the next time point.

In some examples, the determining in this Action 303 may be performed by generating a first predictive model, e.g., a random forest regression model, to predict temperature given past temperature data and time-based features at the site 120 is. In such a first predictive model the response variable may be understood to be the first temperature, which may be the same as the second temperature. The independent variable may be the previous time point first temperature, e.g., shelter temperature, day of the week, hour of the day, minute of the hour. The model parameters may be tuned based on a 70% of training data and 30% of test data. That is, 70% of the obtained information pertaining to temperature may be used to train the first predictive model, and 30% of the obtained information pertaining to temperature may be used to test the predictive power of the trained first predictive model. The metric used to fine tune the first predictive model may be, e.g., Mean Absolute Percentage Error (MAPE).

This Action 303 may be performed, for example, by a temperature prediction module comprised or managed by the first node 101.

By determining the temperature, e.g., the first temperature and the second temperature, in this Action 303, the first node 101 may be enabled to determine a future load of the first passive equipment power source 121, e.g., the DG, factoring in the temperature of the temperature. The first node 101 may then be enabled to calculate the cost of power at the future time source at the first passive equipment power source 121 and at the second passive equipment power source 122, respectively, by being enabled to predict the load. For example, the first node 101 may be enabled to consider the cost computation of using the second passive equipment power source 122, e.g., the battery, in a realistic scenario where the impact of temperature and depth of discharge on the aging of the battery may be addressed, since temperature may have an impact on battery health, as will be explained later.

### Action 304

In embodiments wherein the obtained information in Action 301 may comprise the second information on energy consumption at the network node 110, the first node 101 may, in this Action 304, determine, using the obtained second information, a first load for the first passive equipment power source 121 at the future time period and a second load for the second passive equipment power source 122 at the future time period.

The determination of the first load and the second load may be understood to comprise, in general terms calculating, respectively for each of the first passive equipment power source 121, e.g., the DG, and the second passive equipment power source 122, e.g., the battery, energy consumption per time interval, e.g., in hours.

In order to perform the determination of the first load and the second load at the future time period, the first node 101 may first automatically create, in this Action 304, one or more first features and one or more second features, respectively, from the synchronized and merged, complete data obtained in Action 302, which features may then be input into an AI/ML model, or one or more calculations enabling extrapolation, to forecast the first load and the second load, respectively, at the future time period. A feature may be understood as an independent variable, or a combination of several independent variables, which may be later used to predict a dependent variable. The features created in embodiments herein may be understood to be based on data of the communications system 100, e.g., telecommunications network data. Accordingly, the creation of one or more first features and one or more second features in this Action 304 may further comprise detailed feature engineering involving deep domain knowledge to create features related to the first passive equipment power source 121, e.g., the DG, and the second passive equipment power source 122, e.g., the battery, from the processed information in Action 302, comprising time stamp data.

To then predict hourly load on the energy sources, different network key performance indicator (KPI) data such as traffic, connected users, active users etc. may be used. The KPI data that the first node 101 may use may be understood to be for passive equipment, as will be explained below.

### Determination of the First Load

### a) Creation of the One or More First Features

The first node 101 may, from the processed second information in Action 302, automatically create as a first feature, average load (AVG Load). In embodiments wherein the first passive equipment power source 121 may be the DG, the average load may be calculated from Meter Kilo Watt per hour (MeterKWh2) from a first source of data on the first passive equipment power source 121. The time period of the load may be calculated from the different between a first time period when the first passive equipment power source 121 may have been turned off and a second time period when the first passive equipment power source 121 may have been turned on, e.g., based on a parameter indicating a date and time of the capture of On and Off timestamps. The first node 101 may determine the first load as the average load according to the following formula:

$$Avg Load = ( MeterKWH 2 when DG switched off - MeterKWH 2 when DG switched on ) / Time period in Hrs from DG switched on to off$$

### b) Forecast of the First Load

The first node 101 may determine the first load at the future time period by generating a second predictive model, e.g., based on AI/ML, given input data on independent variables, at a given time point. The second predictive model may be a catboost regression model to predict the first load based on data obtained at earlier time points.

In embodiments wherein the first passive equipment power source 121 may be the DG, the first load may be, e.g., a DG load. In the second predictive model, the response variable may be energy consumed at the future time period, e.g., as a column name in the merged data ‘consumed_in_15_minutes’, and the independent variables may comprise the first temperature, e.g., shelter temperature, in a previous time point, e.g., the previous 15 min aggregation, and the second information, e.g., the energy consumption in the previous time point, comprising day of the week, hour of the day, minute of the hour.

According to the foregoing, the determined first load may be a prediction of the first load, e.g., a prediction of DG load, understood as the energy consumption via the first passive equipment power source 121, e.g., the DG, for the future time period, e.g., the next 8 time points, where the time unit may be taken as 15 min. In other words, the first node 101 may predict the DG load for the time interval of the immediate future 8 consecutive 15 min time intervals, based on data obtained at earlier time points.

In some examples, the first node 101 may, for each current time point, and using the predicted temperature as input, predict next 8 time point DG load in the same hierarchical way as the temperature prediction mentioned earlier, namely, the first node 101 may predict the next time point first load and hierarchically continue to predict the first load corresponding to the 8 time points by considering each predicted temperature as the lag one temperature input to predict the first load for the next time point.

The hyperparameter of the second predictive model may be tuned with a 70-30 division of data. The performance metric used may be MAPE. It may be noted that for the training, only energy consumption data from the first passive equipment power source 121, e.g., the DG, and Electricity Board (EB) related energy consumption data may be considered.

The determination of the first load in this Action 304 may be performed, for example, by a first load prediction module, e.g., DG load prediction module, comprised or managed by the first node 101.

### Determination of the Second Load

### a) Creation of the One or More Second Features

The first node 101 may, from the processed second information in Action 302, automatically create as one or more second features, discharge Kilo Watt per hour (KWH) and Percentage charge discharge energy. The percentage discharge of the battery may be one of the created one or more second features and it may be calculated as follows. For a single site, such as the site 120, and single channel, where a channel may be understood to be a column that may hold data, e.g., battery, DG or grid related data:
1. Obtain the time difference from previous data point, e.g., in hours;
2. For battery current, which is positive, the discharge=0;
3. For battery current which is negative, the amount of discharge=current time difference, coming from step 1;
4. To calculate percentage, divide the amount of discharge by AH capacity;
5. Repeat the same for all channels.

To identify the battery channels, the first node 101 may perform the following:
1. Check the sign of all 8 channels currents;
2. If the current has both positive and negative values, that may be understood to mean that it is charged and discharged; this may be understood to be the indication of a battery channel.

The energy consumed/discharged by the battery may be another of the created second one or more second features and it may be calculated as follows:
1. Energy consumed or discharge may be calculated by power * timestamp.
2. Power may be understood as the multiplication of average voltage and average current.
3. For a battery channel, if the current is positive, that may be understood to mean that the battery is charged. Hence, it may be understood to indicate energy consumed by the battery.
4. If the current is negative, that may be understood to mean that electric current may be flowing out of the battery and this may be understood to indicate the state of battery discharge.

### b) Forecast of the Second Load

The second load may be determined in a manner equivalent to the determination of the first load, namely, energy consumption per time interval, e.g., in hours, by using one or more domain knowledge based rules, given input data on independent variables, at a given time point. In particular, in examples wherein the the second passive equipment power source 122 may be a battery, the second load may be the battery load. The second load for the future time period may be determined as a predicted discharge KWH, which may be extrapolated from the second load calculated from the last timestamp available to the next 8 timestamps.

By determining the first load and the second load at the future time period in this Action 304, the first node 101 may then be enabled to determine the cost of power for each of the first passive equipment power source 121 and the second passive equipment power source 122 at the future time period, as will be explained in detail in the next Action 305.

### Action 305

In this Action 305, the first node 101 may determine a first cost of power of the determined first load at the first passive equipment power source 121 at the future time period and a second cost of power of the determined second load at the second passive equipment power source 122 at the future time period.

In general terms the determination of the cost may be understood to be determined as cost per time unit. The future time period may be, for example, the next 15 m, 30 m, 45 m, 60 m, 75 m, 90 m, 105 m or 120 m.

The first node 101 may be understood to need to calculate the first cost and the second cost for future a timestamp in order to compute the potential cost and hence recommend the optimal energy source.

### Determination of the First Cost

### a) Creation of the One or More Third Features

The first node 101, in examples wherein the first passive equipment power source 121 may be the DG, may automatically create as a third feature, from the processed second information in Action 302, a per hour DG cost. The per hour DG cost may be calculated using additional third features, particularly: cost of fuel, the first load e.g., Consumption per Hour (CPH) and cost of Preventive Maintenance (PM), according to the formula shown below:

$$Per Hour DG cost = ( CPH * Fuel Cost ) + ( Cost\_PM / Runhours\_PM )$$

CPH may be understood as a consumption of fuel per hour, calculated. Fuel Cost may be understood as a predicted Cost of Fuel per liter, from stored data. These stored data may be understood to be a source of some types of data which may be related to sites such as the site 120, and may be understood to not change much over days. Once in a month these data may be updated. Cost_PM may be understood as a Cost of one Preventive Maintenance, from the stored data. Preventive Maintenance may be understood as a periodic maintenance to prevent malfunctioning of an equipment from wear and tear generated by continuous running of the equipment. Runhours_PM may be understood as a number of hours before one PM, from the stored data.

In some examples, the first cost may be calculated considering the second equipment power source 122, e.g., the battery, as one of the loads, for example when the second equipment power source 122 may be being charged by the first equipment power source 121. In such examples, the first cost may be calculated as follows, e.g., in examples wherein the first equipment power source 121 may be the DG and the second equipment power source 122 may be the battery:

$$DG Cost = Cost for charging battery using DG + Cost for energy to other equipment + maintenance \\ Energy consumed by battery channel = Voltage * Current * time ( hrs ) / 1000 \\ Total energy consumed by battery = sum of energy consumed by all battery channels \\ Output energy by DG which may be used by battery = Total energy consumed by battery / rectifier efficiency , since some energy loss may be present when the rectifier may convert from Alternating current ( AC ) to Direct current ( DC ) .$$

CPH of Output energy by DG for battery charging and Total CPH of DG may be used to calculate Fuel consumed for Battery charging.

### b) Forecast of the First Cost

The first node 101 may then determine the first cost from the energy consumption using the determined third features, given input data on independent variables, at a given time point, Cost of using the first passive equipment power source 121 per KWH and absolute cost of the first passive equipment power source 121 in given time period using the following formulas:

first passive equipment power source 121 Cost per KWH=Per Hour first passive equipment

$$power source 121 cost / Avg Load$$

It may be noted that in this section, Avg Load is a predicted quantity.

Absolute cost of first passive equipment power source 121 in given time period=Per hour cost/# of timestamps per hr

In embodiments wherein the first passive equipment power source 121 may be the DG, the first cost at the future time period may be, e.g., DG future cost. In such examples, the first cost
may be calculated according to the following formulas: DG Cost per KWH and Absolute cost of DG in given time period.

DG Cost per KWH, may be calculated using the predicted avg load, as described above, and per hour DG cost, as just described, according to the formula below:

$$DG cost per KWH = Per Hour DG cost / Avg Load$$

Absolute cost of DG in a given time period may be calculated as according to the formula below:

Absolute cost of DG in given time period=Per hour cost/# of timestamps per hr

Cumulative DG absolute may be also calculated and used for comparison. Cumulative DG absolute may be understood to be an added value up to a time point. For example, for a consecutive 8 interval, a cumulative value corresponding to an interval may be understood to be a sum of all values up to and including that interval.

In some examples, the first node 101 may predict, for each current time point at the site 120, the cumulative DG cost prediction for the next 8 time points.

The precursor of the prediction of the first cost, e.g., of the DG cost, may be the following two features: i) the determined first load at the first passive equipment power source 121 at the future time period, which may comprise DG energy consumption for the next 8 timestamps of the site 120, as predicted based on previous data in Action 304, and ii) the first temperature at the first passive equipment power source 121 at the future time period, as calculated in Action 302, which may comprise the temperature prediction for next 8 time points, where the time unit may be taken as 15 min.

### Determination of the Second Cost

### b) Creation of the One or More Fourth Features

In order to determine the predicted second cost at the future time period, the first node 101 may first automatically create one or more fourth features, which may then be used as input variables for a model used to perform the prediction.

In embodiments wherein the second passive equipment power source 122 may be a battery, the one or more fourth features may comprise: cost of discharge energy, cost of aging of battery including temperature effect, effective Ampere-Hour (AH) capacity, state of battery, cost of per unit charge in batteries of the site 120, and absolute cost of DG usage for every interval, e.g., 15 minutes. These one or more fourth features may then be aggregated to 15 minutes.

a.1.) The cost of discharge energy may be understood as a cost of charging the battery by consuming supplied electric power to the battery while charging.

The first node 101 may determine the cost of charging the battery as follows:
1. First, the first node 101 may calculate the energy consumed by the battery for every timestamp.
2. For every timestamp, the first node 101 may also determine the power source. For example, the power source may be a DG or the grid.
3. The first node 101 may need to have a per unit energy cost of the respective power source.
4. Then, the first node 101 may multiply the cost of per unit energy, and the amount of energy that may be required for charging the battery, specific to the power source.
5. The first node 101 may take the sign of the current into consideration. Negative current may need to be excluded from the calculation. It may be equated to zero because there may be understood to be no charging.
6. The data points where trickle charge may be happening may be excluded.
7. The first node 101 may replicate these steps for all the channels in the site 120.

a.2) The cost of the aging of the battery, or health of the battery, may be understood to derive from the fact that a battery may be understood to come with a fixed age health and it may be understood to be directly related to the aging of the battery. Therefore, it may be understood that a battery which is older may have lesser health, and this may reflect in the present AH hello capacity of the battery. The first node 101 may consider the battery cost computation in a realistic scenario, where the impact of temperature and depth of discharge on the aging of the battery may be factored in. Any battery may be understood to be specified to work at a certain temperature. Any increase in the temperature from the specified value may then be understood to reduce the present AH capacity of the battery. When the temperature is <=27 degree C., there may be no effect of the temperature on aging. However, when the temperature is above 27 degree C., there may be a 5% decrease in the life of a lead-acid battery, for every 1 degree centigrade rise in temperature. According to the foregoing, the impact of the temperature on the health of the battery may be calculated as follows:

$$Effect\_from \_temp = ( 1 - ( temp . ShelterTemperature - 27 ) * 0.05 ) . Effect of temperature adjusted cost = Cost / Effect\_from \_temp$$

a.3) The effective AH capacity may be understood as the capacity of the battery in AH. The effective AH capacity may reduce as aging of the battery may take place. The factor of aging may come from historical data, e.g., first historical data, of another Energy Infrastructure Operations (EIO) use-case.

a.4) The state of battery may be understood as the functional state of the battery where the battery may be either discharging or getting charged. Examples of the state of battery may be, e.g., charge, discharge, trickle. The state of the battery may be identified as follows. If the current is positive and less than 1% of AH capacity, the state of the battery may be understood to be trickle charging. If the current is positive and more than 1% of each capacity, the state of the battery may be understood to be charging from the power source. If the current is negative, the state of the battery may be understood to be discharging.

In some examples, the second cost may be calculated considering the second equipment power source 122, e.g., the battery, being charged by the first equipment power source 121. In such examples, CPH of Output energy by DG for battery charging and Total CPH of DG may be used to calculate Fuel consumed for Battery charging and in turn cost for battery charging.

### b) Forecast of the Second Cost

The second cost may be extrapolated, that is, predicted, from the second load calculated in Action 304 by using one or more domain knowledge based rules. For embodiments wherein the second passive equipment power source 122 may be a battery, the future second cost may be calculated by extrapolating the second load, that is, the battery load as discharge KWH, from the load calculated from the last timestamp available, to the next 8 timestamps.

The State of Charge (SOC) of the last time stamp may be taken and based on it, the discharge KWH for the next eight SOC may be calculated.

The SOC may be calculated by the first node 101 as follows:
1. The first node 101 first assume an initial SOC of 100;
2. For every subsequent timestamp, the first node 101 may then multiply the time difference from the previous data point and the electric current. This may give the amount of charge disappeared in that time.
3. So the new SOC may be 100—amount of charge disappeared coming from Step 2.
4. The depth of discharge (DOD) may always be calculated as 100—SOC.

As SOC increases, there may be an impact on the charging current. For lead acid, the current may reduce 10% of AH, as the battery may charge. Hence, the charging may be understood to not be linear. For lithium-ion, the current may decrease with charging, but less compared to a lead-acid battery.

The first node 101 may calculate the aging of the battery from the calculated SOC for a discharge cycle, based on Table 1 as follows as follows. Assuming that the initial SOC is 100. If battery discharges to zero, there may be 600 discharge cycles. Similarly, if the battery discharges to 20% there may be 800 cycles and so on.

TABLE 1

| % SOC | % DOD | Cycles |
|---|---|---|
| 0% | 100% | 600 |
| 20% | 80% | 800 |
| 40% | 60% | 1200 |
| 60% | 40% | 1500 |
| 80% | 20% | 1800 |

In a practical scenario, the charging may be understood to not be 100% every time, so the calculation may differ. Normally, a cycle may comprise both charging and discharging. A mapping may be required between charging and discharge data points. That is, to identify two consecutive cycles where charging has happened and then discharging has happened. The first node 101 may add the effect of temperature while calculating the cost of aging. The effect of other factors of aging such as rate of discharge and voltage may be explored.

The first node 101 may also determine the cost of per kwh energy remaining in the battery. The battery may be understood to be be charged, discharged to different SOCs using the DG and the grid multiple times. Hence, the first node 101 may need to determine a running cost of charge present in the battery. The first node 101 may follow below procedure to achieve it.

$$Cost of present charge ( Chg ) ( A ) = ( Chg energy when grid is the source * Grid per unit cost ) + ( Chg energy when DG is the source * DG per unit cost ) . \qquad 1$$

$$Total cost of charge in batt ( B ) = ( Previous B - Previous B * ( SOC at previous “ end of chg ” - SOC at last “ end of dischg ” ) ) + Present A ; Previous B may be understood as the latest Total cost charge in the battery in the previous cost calculation cycle . \qquad 2$$

$$Present B / Effective batt capacity in kWH . \qquad 3$$

The absolute cost of battery usage for every interval, e.g., 15 minutes may be understood as the cost of using the battery in a time interval to supply electricity to run equipment, e.g., a cumulative sum of the charging cost calculated every 15 min. Whenever discharge may happen, the first node 101 may subtract the corresponding amount based difference of SOC at start and SOC at end of discharge. For example, if the total cost is 10000, and after a discharge, the SOC goes from 100 to 90%, the new total cost may be understood to be 10000−(1−0.9)*10000.

Capital Expenditure (Capex) cost may be calculated using Table 1, that is, the SOC_cycles table and the temperature, assumed as the last value.

The discharge energy cost per KWH may be assumed to be the same as the last value, and the total cost may be calculated for the next eight-time stamps.

Finally, the battery energy cost may be calculated as follows:

$$Battery Energy cost = Discharge energy cost + cost due to aging$$

Table 2 illustrated a table that may be obtained performing the foregoing calculations to obtain the predicted total cost/KWH:

TABLE 2

| kWH for 15 | | | | | | Add all this |
|---|---|---|---|---|---|---|
| minutes | | | | | | for all |
| 0.405 | | | | 5 | 1 | batteries |
| 30*54*0.25 | 2 | 3 | | CAPEX used | Discharge | 6 |
| 30 Amp | Discharge | Discharge | 4 | (aging cost with | energy | total |
| 1 | time(hrs) | kWH | SOC | temperature included) | cost/kWH | cost/kWH |
| | 0.5 | 0.81 | 90% | 200 | 3173 | 3420 |
| | 1 | 1.62 | 80% | 410 | 3173 | 3426 |
| | 1.5 | 2.43 | 70% | 630 | 3173 | 3432 |
| | 2 | 3.24 | 60% | 850 | 3173 | 3435 |
| | 2.5 | 4.05 | 50% | 1000 | 3173 | 3420 |
| | 3 | 4.86 | 40% | 1300 | 3173 | 3440 |

In some examples, the first node 101 may predict, for each current time point at the site 120, the access cumulative battery cost prediction for the next 8 time points. Thus, the costs may correspond to running the battery for next 15/30/45/ . . . /105/120 minutes.

According to the foregoing description of Action 305, in some embodiments, at least one of the following options may apply. According to a first option, the determining in this Action 305 of the first cost may be further based on a first cost of maintenance of the first passive equipment power source 121 at the future time period. According to a second option, the determining in this Action 305 of the first cost may be further based on a cost of charging the battery. According to a third option, the determining in this Action 305 of the second cost may be further based on at least one of: state of charge of the battery, aging of the battery, temperature, depth of discharge (DoD), and source of recharge of the battery.

By the first node 101 determining the first cost and the second cost in this Action 305, the first node 101 may be enabled to then compute the potential cost of using first passive equipment power source 121 and the second passive equipment power source 122, and hence recommend the optimal energy source accordingly, as described in the next Action 306.

### Action 306

In this Action 306, the first node 101 determines, using machine learning and the obtained information, a source of power to be used by the network node 110 at the future time period, out of the first passive equipment power source 121 and the second passive equipment power source 122. The determining in this Action 306 may be based on an estimated cost of the power, and the estimated load at the power source during the time period.

The determining in this Action 306 may be performed by comparing the first cost, e.g. DG cost and the second cost, e.g., the battery cost, for the corresponding cumulative interval and identifying the source of power with the lower cost, which may also be understood to be the source of power with the lower carbon footprint. The first node 101 may identify the interval and the corresponding lesser cost resource. In other words, the complex optimization problem of the power source may be translated, according to embodiments herein, into a simple interval wise cost comparison problem, which may be understood to enhance the computational efficiency manifold by reducing computational complexity and time. Hence the whole power source optimization problems boil down to power switching recommendation to optimal source. That the determination in this Action 306 is performed “using machine learning” may be understood to refer to the fact that machine learning may have been used to create the quantities that are being compared in this Action 306, as described in the previous actions.

The determining in this Action 306 of the source of power to be used by the network node 110 at the future time period may be based on the processed information in Action 302.

The estimated load at the power source during the time period may be understood to comprise the determined first load and the determined second load for the future time period in Action 304. That is, the determining in this Action 306 of the source of power to be used by the network node 110 at the future time period may be based on the determined first load and the determined second load in Action 304. The first node 101 may calculate the future duration of how long the second passive equipment power source 122, e.g. the battery may be able to supply power based on calculated SOC and second load and may use this calculation in the optimal power source recommendation.

The estimated cost of power during the time period may be understood to comprise the determined first cost and the determined second cost for the future time period in Action 305. The estimated cost of the power may be based on the determined first temperature and the determined second temperature in Action 303.

In any of the predictive models used in Action 303 and Action 304 to forecast the first temperature, the second temperature and the first load, the first node 101 may apply a model based interpolation to mitigate the interpolation quality issue in a dynamic data scenario.

In some embodiments, the determining in this Action 306 of the source of power to be used by the network node 110 at the future time period may be triggered by an outage of the active power source 123 at the network node 110. This may be so that the network node 110 may be able to choose the most optimal power source, or most optimal combination of power sources, from e.g., battery and DG, when the active power source 123, e.g., the grid, may not be available due to power outage. In some examples, the first node 101 may predict the duration of the outage of the active power source 123 to make the automated application safer, as it may create scope for pro-active mitigation of power shortage.

In the determination performed in this Action 306, the first node 101 may be understood to follow a hybrid approach by combining optimisation and forecasting.

By the first node 101 determining the source of power to be used by the network node 110 at the future time period in this Action 306, the first node 101 may be enabled to utilize network data to identify the optimal energy source for the future time period for energy optimization, and churn out a recommendation accordingly, e.g., on a real time basis. This may enable a passive equipment power consumption saving via optimal recommendation, which may be understood to translate into significant cost savings. Passive equipment based energy cost saving may be derived from a combination of savings in daily consumption of fuel, electricity cost, e.g., savings from DG and grid usage.

For example, the first node 101 may be enabled to forecast low network activity, and hence recommend to use a source with low cost such as a low load bearing source e.g., a battery.

The first node 101 may thereby enable a cost minimization of the visits to the site 120 related to passive infrastructure, for example, because of the optimal DG usage and hence the less frequent refuelling requirement.

Furthermore, by translating the complex optimization problem of the power source may into a simple interval wise cost comparison problem, the first node 101 may enable to enhance the computational efficiency manifold by reducing computational complexity and time. Hence the whole power source optimization problem may be boiled down to a power switching recommendation to the optimal source. The first node 101 may enable that the level energy requirement at the site 120 may be optimally served via a controlled operation of power source switching.

### Action 307

In this Action 307, the first node 101 provides a first indication indicating the determined source of power to at least one of the network node 110 and the second node 102 operating in the communications system 100.

The providing in this Action may be e.g., publishing, sending or transmitting, e.g., via the first link 151.

The first node 101 may, in this Action 307, publish the recommendation of the optimal source by publishing the interval start-end time as the resource operating interval.

The first indication may be, for example, a message to the second node 102, which may be a device managed by a controller of the site 120. The first indication may comprise, for example, an instruction, e.g., which source of power to use between the first passive equipment power source 121 and the second passive equipment power source 122, along with an indication of for how much time to run it, if the need arises. The first indication may also comprise an identifier (ID) of the instruction, as an Instruction ID, a date and time of the of the instruction, and a time for which this instruction may be valid, that is, by which time the next instruction may be generated.

By sending the first indication to the network node 110, the first node 101 may enable the network node 110 to choose the most optimal power source, or most optimal combination of power sources, from e.g., battery and DG, when the active power source 123, e.g., the grid, may not be available due to power outage. Accordingly, a large amount of energy and a high carbon footprint may be enabled to be saved.

By sending the first indication to the second node 102, the first node 101 may also initiate Trouble Tickets and actionable Work Orders and may recommend actions for improving energy efficiency of the site 120, site visit optimization, network performance and

Total Cost of Ownership. The second node 102 may be enabled to then initiate an action to handle the recommendation.

In some embodiments, the first node 101 may further repeat the method of Actions 301-307 periodically. By doing so, the first node 101 may then churn its recommendation of the optimal alternative power sources, e.g., serial combination of DG and battery, for the immediate next future hours, continuously, on a real time basis. This recommendation may be intended to be used when the active power source 123 may be under power outage and hence, the first node 101 may enable to help to manage the site 120 consistently.

This solution can easily run on an automated software module as a continuous site energy control tool and can strike a balance between service continuity and optimal energy usage by enhancement of battery power utilization.

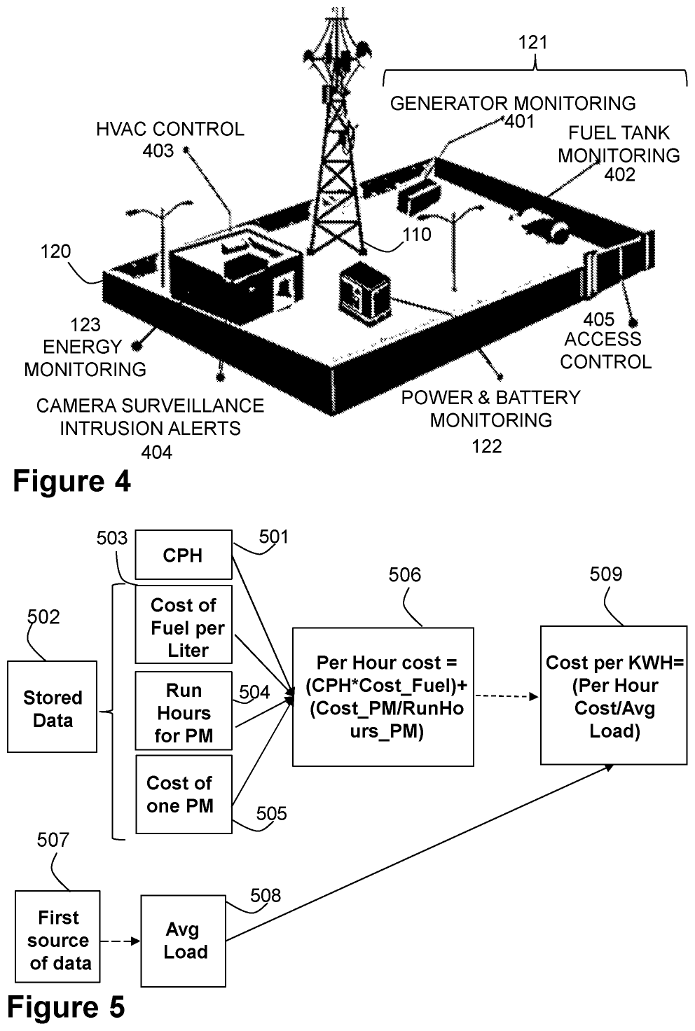

FIG. 4 is a graphical representation of a non-limiting example of the site 120. As depicted in this example, the site 120 comprises the network node 110, the first passive equipment power source 121, the second passive equipment power source 122 and the active power source 123. The first passive equipment power source 121 comprises a generator 401 and a fuel tank 402, each of which enable monitoring of their use to enable the first node 101 to obtain information about the first passive equipment power source 121. Similarly, the second passive equipment power source 122 enables the first node 101 to obtain information about power and battery monitoring, and the active power source 123 enables the first node 101 to obtain information regarding energy monitoring. In this particular example, the site comprises a further passive equipment power source 403 as HVAC equipment, which may comprise a respective control device. The site also comprises a camera 404 enabling to perform surveillance and report intrusion alerts, as well as an access control device 405 at the gate to the site 120.

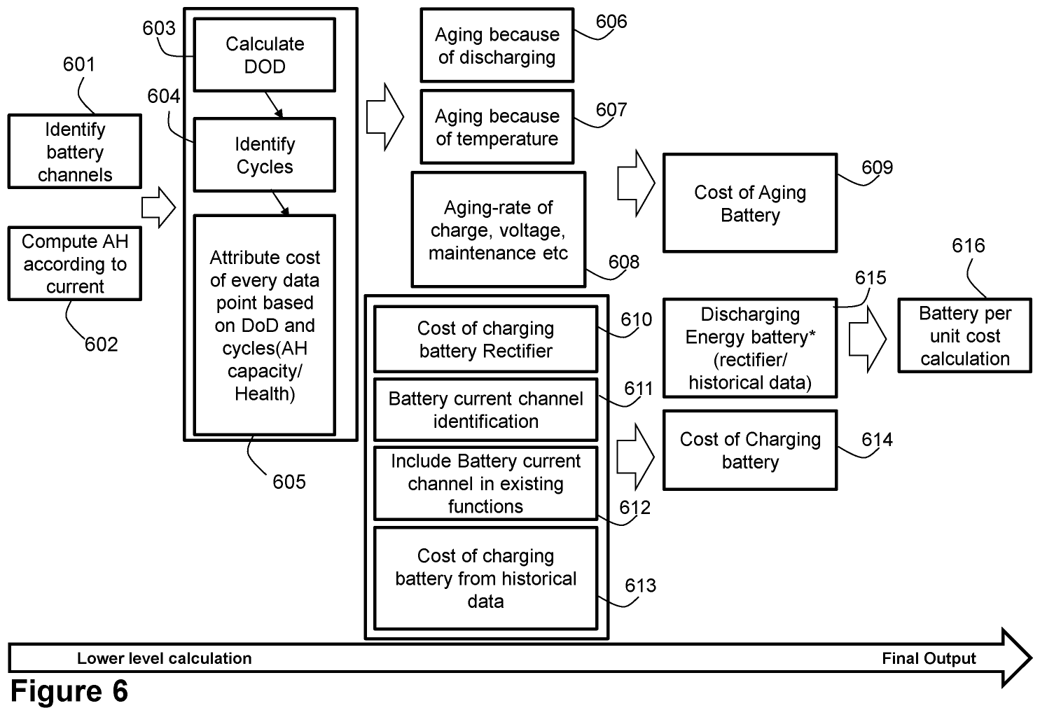

FIG. 5 is a schematic block diagram graphically illustrating, in a non-limiting example, how the cost of energy per unit from the diesel generator may be calculated based on the one or more third features, according to embodiments herein in Action 305. The first node 101 calculates the CPH 501 and from the stored data 502, the cost of fuel per liter 503, the run hours for PM 504, and the cost of one PM 505. From these values, the first node 101 may calculate the per hour cost of the DG 506 as Per Hour DG cost=(CPH*Fuel Cost)+(Cost_PM/Runhours_PM). From the first source of data on the first passive equipment power source 121 507, the first node 101 may calculate the Avg load 508. Then, based on the Avg load 508 and the per hour cost of the DG 506, the first node 101 may calculate the DG Cost per KWH 509 as DG Cost per KWH=Per Hour DG cost/Avg Load.

FIG. 6 is a schematic block diagram graphically illustrating, in a non-limiting example, how the cost of battery per unit energy present in batteries in the site 120 may be calculated based on the one or more fourth features, according to embodiments herein in Action 305. The first node 101 may first identify the battery channels 601 and compute the AH according to the current 602. The first node 101 may then calculate the DOD 603 and based on the DOD 603 may identify the cycles 604. Based on the DOD 603 and the identified cycles 604, the first node 101 may then attribute the cost of every data point as AH capacity/Health of the battery 605. The first node 101 may then calculate the aging because of the discharging 606, as described earlier in Action 305 for “the aging of the battery from the calculated SOC” the aging because of the temperature 607, as described earlier in Action 305, and the aging-rate of charge, voltage, maintenance, etc. 608, and based on these three calculations, the first node 101 may then calculate the cost of aging of the battery 609. The first node 101 may additionally calculate the cost of charging the battery rectifier 610, as described in Action 305 for the “cost of per kwh energy remaining in the battery”, the battery current channel identification 611, include the battery current channel in existing functions 612, that is, update the computational approach that may have been considered with a single battery channel, with each additional battery channel for a new site, and the cost of charging the battery from a second source of data, e.g., a source of second historical data, on battery usage at the site 120 613, which calculation may be understood to be different from that of the rectifier. From these fourth last values, the first node 101 may then calculate the cost of charging the battery 614. The first node 101 may also calculate the discharging of the energy of the battery as the cost of charging the battery rectifier or from the second historical data 615, and from this value, the cost of aging of the battery 609, and the cost of charging of the battery 614, calculate the cost of the battery per unit 616.

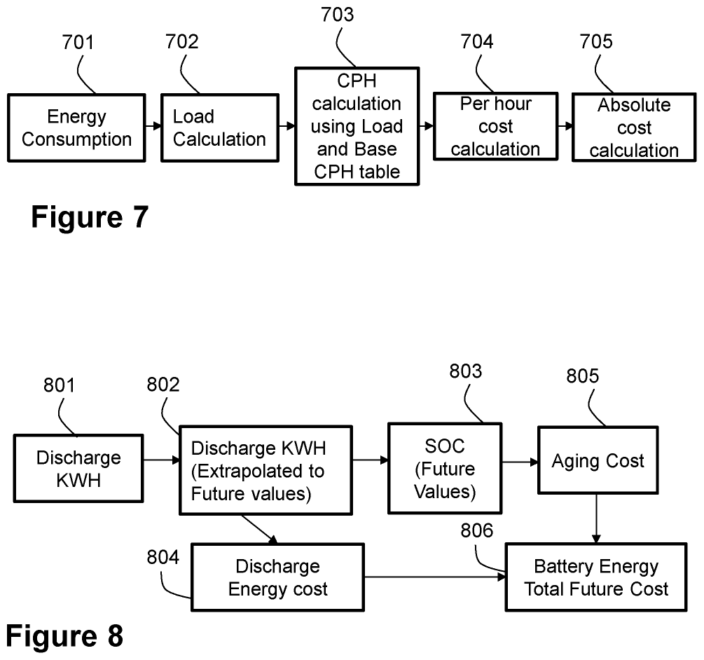

FIG. 7 a schematic block diagram graphically illustrating, in a non-limiting example, how the first cost may be calculated based on the one or more third features, according to embodiments herein in Action 305. The first node 101 may predict the energy consumption at the site 120 for the next 8 timestamps at 701. Based on that, the first node 101 may calculate the load at 702 as Load Calculation =Energy Consumption/time interval in hours. The first node 101 may then calculate the CPH using the first load and the base CPH table at 703. Based on this calculation, the first node 101 may calculate the per hour cost calculation 704 as Per hour cost=(CPH*Cost_Fuel)+(Cost_PM/RunHours_PM). Finally, the first node 101 may calculate the absolute cost of the DG in a given time period at 705 as Absolute cost of DG in given time period=Per hour cost/# of timestamps per hr.

FIG. 8 a schematic block diagram graphically illustrating, in a non-limiting example, how the second cost may be calculated based on the one or more fourth features, according to embodiments herein in Action 305. The first node 101, based on the discharge KWH 801, may predict the discharge KWH extrapolated to the future values 802, and based on that, calculate the future values of SOC and the 803 and the discharge energy cost 804. Based on the SOC future values 803, the first node 101 may calculate the aging cost 805, while based on the discharge energy cost 804 the first node 101 may calculate the battery energy total future cost 806.

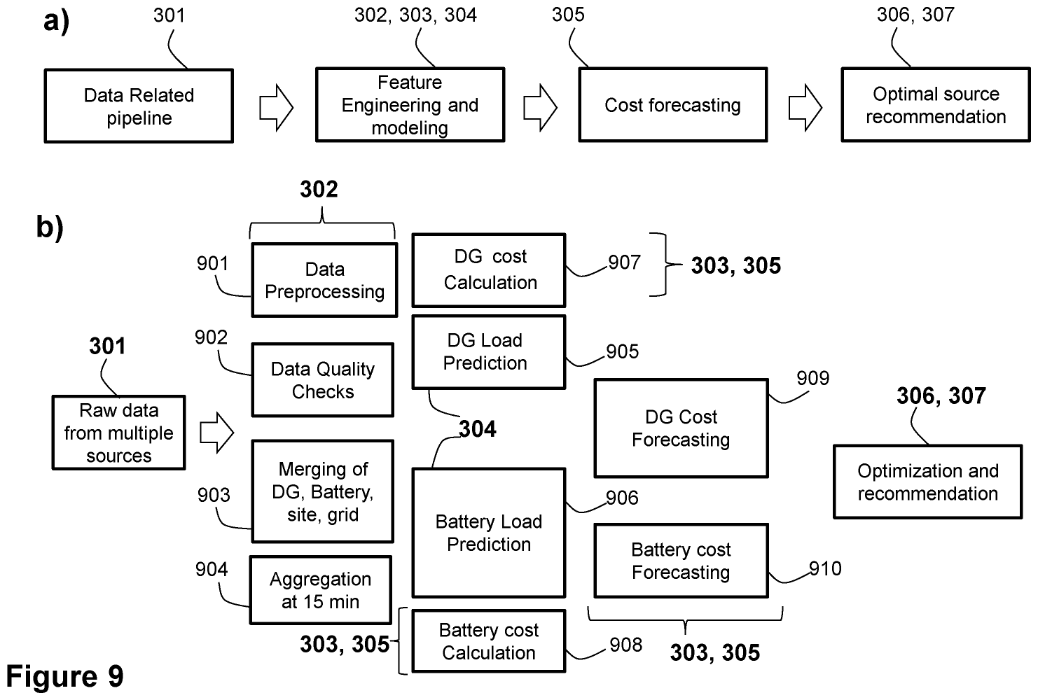

FIG. 9 schematic block diagram graphically illustrating a summary of the different actions the first node 101 may perform according to embodiments herein, during the creating of the different predictive models described. In panel a), the actions are depicted, grouped in four main steps. First, in accordance with Action 301, the first node 101 obtains a data related pipeline, by obtaining the information. Next, in accordance with Action 302, Action 303 and Action 304, the first node 101 performs feature engineering and modelling to predict the first load and the second load. Based on the predicted first load and second load, the first node 101, according to Action 305 performs cost forecasting, and based on the cost forecasting, the first node 101 may then determine an optimal source recommendation, and provide the recommendation, in accordance with Action 307. In panel b) of FIG. 9, the different actions are schematically depicted with more detail. First, in accordance with Action 301, the first node 101 obtains the raw data from multiple sources. Then, in accordance with different aspects of Action 302, the first node 101 performs data preprocessing at 901, data quality checks at 902, merges data from the first source of data on the first passive equipment power source 121, data from the second source of data on the second passive equipment power source 122, data on the active power source 123 and stored data on the site 120 at 903, and aggregates the data at e.g., 15 minute periods at 904. Based on the processed information, and in accordance with Action 304, the first node 101 then determines the first load at 905, here a DG load prediction, and the second load at 906, here a battery load prediction. Next, in accordance with Action 305, and based on the determination of Action 303, the first node 101 then calculates the DG cost at 907 and the battery cost at 908, which then enables the first node 101 to predict in accordance with Action 305, and based on the determination of Action 303, the first cost, here the DG cost forecast at 909, and the battery cost forecast at 910. Finally, based on the first cost and the second cost, the first node 101 can perform the optimization of the usage of the power source in Action 306, and provide the recommendation in accordance with Action 307.

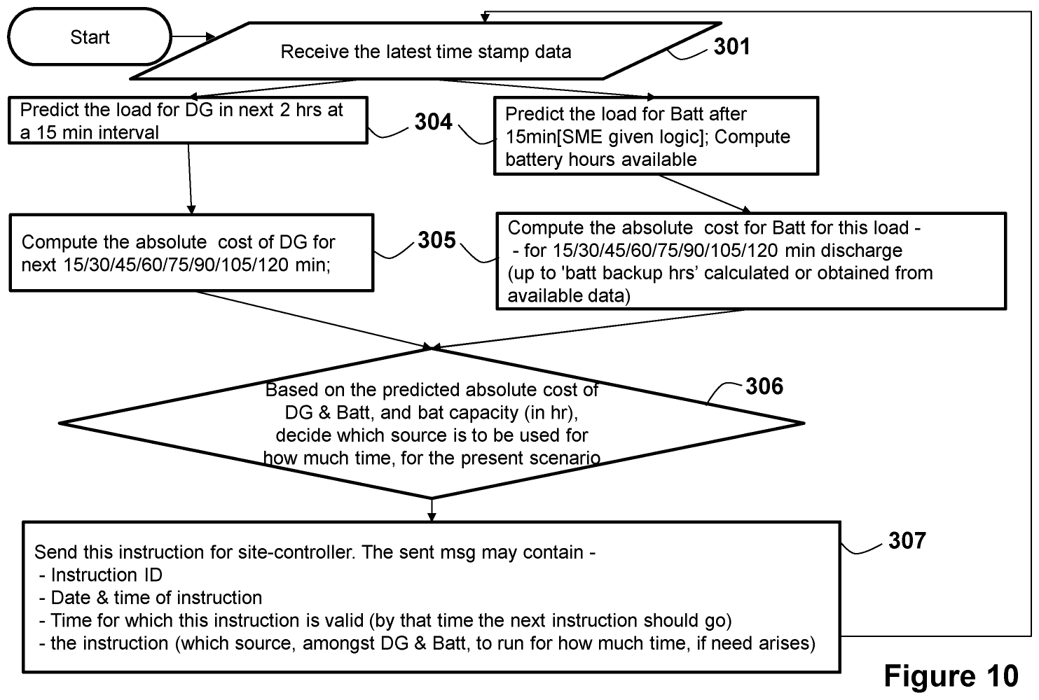

FIG. 10 schematic block diagram graphically illustrating, with a non-limiting example, the different actions the first node 101 may perform according to embodiments herein, once the different predictive models described herein may have already been built. In accordance with Action 301, the first node 101 may receive information as the latest time stamp data. Then, in accordance with Action 304, the first node 101 may determine: the first load, here the load for the DG, in the next 2 hours at a 15 min interval and the second load, here the load for the battery after 15 minutes using SME logic. The first node 101 may also compute the hours the battery may be available for. Next, in accordance with Action 305, the first node 101 may calculate the first cost as the absolute cost of the DG for the next 15, 30, 45, 60, 75, 90, 105 and 120 minutes, using the predicted first load. The first node 101 may also calculate, in accordance with Action 305, the absolute cost for the battery given the calculated second load, for 15, 30, 45, 60, 75, 90, 105 and 120 minutes of discharge and up to the battery backup hours received from the a third source of data comprising static data about the site 120.1, that is, how long the battery may be able to support power supply. Next, based on the first cost, here the predicted absolute cost of the DG, and the second cost, here the predicted absolute cost of the battery, and the calculated battery capacity, in hours the first node 101 decide, in accordance with Action 306, which source is to be used for how much time, for the present scenario. Finally, in accordance with Action 307, the first node 101 may send the first indication as a message to the second node 102, here a device managed by the controller of the site 120. The sent message may comprise: an identifier of the instruction (Instruction ID), a date and time of the of the instruction, a time for which this instruction may be valid, that is, by which time the next instruction may be generated, and the instruction, e.g., source, amongst DG and battery and to run for how much time, if the need arises.

As a summarized overview of the foregoing, embodiments herein may be understood to consider power utilization optimization at a telecommunications network node, that is, at a base station, which may be understood to be a telecommunications native problem. Hence, embodiments herein may be understood to provide a telecommunications specific solution. Embodiments herein may be understood to have an end-to-end application, starting from the feature creation, e.g., battery and DG related feature creation, load and hence power cost forecasting, e.g., using AI/ML, leading to a pro-active power source recommendation ensuring optimization of energy cost. Embodiments herein may therefore be understood to follow an approach comprising a mixture of forecasting and optimization.

Embodiments herein may provide one or more of the following advantages. In a general sense, embodiments herein may be understood to enable energy management via AI/ML application in the optimization of passive equipment energy usage in a telecommunications site such as the site 120. AI-powered energy management solutions may be used, according to embodiments herein to perform advanced data analytics to meet rising data demands, while lowering operational and capital expenditure. The optimization enabled by the first node 111 may enable to have an accurate overview on the performance of the energy at the site 120, and identify if the site 120 may have any issues. As a particular advantage, embodiments herein may be understood to enable a reduction in fuel consumption and energy cost. For example, a reduction of DG run hours may lead to important savings for reducing fuel spent. Customer Service Providers (CSPs) may achieve an approximate 15 percent reduction of energy related OPEX.

As another particular advantage, embodiments herein may be understood to enable an improvement in the availability of the communications system 100. An estimated approximate 30 percent reduction in energy-related outages may be achieved. The improvement in the availability of the communications system 100 may advantageously enable a reduction in the load of the operations.

As a further particular advantage, embodiments herein may be understood to enable an improved management of the energy resources. Furthermore, embodiments herein may enable a reduction in the number of visits to the site 120 due to refueling. An estimated approximate 15 percent reduction in visits to the site 120 related to passive infrastructure may be achieved.

Yet as another particular advantage, embodiments herein may be understood to enable a reduction in CO₂ emissions, since DG will not always be used, in a fixed manner, as a first choice for source of power, in case of outage of the active power source 123.

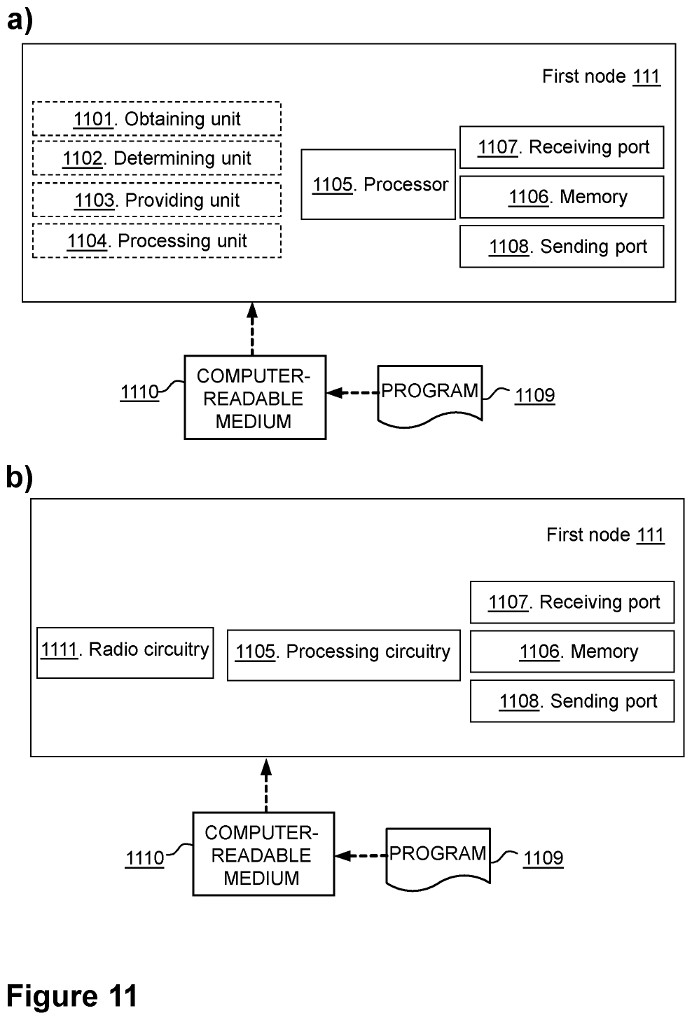

FIG. 11 depicts two different examples in panels a) and b), respectively, of the arrangement that the first node 101 may comprise to perform the method actions described above in relation to FIG. 3, and/or FIGS. 4-10. In some embodiments, the first node 101 may comprise the following arrangement depicted in FIG. 11a. The first node 101 may be understood to be for determining a source of power. The first node 101 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 11, optional boxes are indicated by dashed lines. The detailed description of some of the following corresponds to the same references provided above, in relation to the actions described for the first node 101 and will thus not be repeated here. For example, in some embodiments, the first passive equipment power source 121 may be configured to be a DG and the second passive equipment power source 122 may be configured to be a battery.

The first node 101 is configured to, e.g. by means of an obtaining unit 1101 within the first node 101 configured to, obtain the information about the first passive equipment power source 121, the second passive equipment power source 122 and the active power source 123 of the network node 110.

The first node 101 is also configured to, e.g. by means of a determining unit 1102 within the first node 101 configured to, determine, using machine learning and the information configured to be obtained, the source of power to be used by the network node 110 at the future time period. Out of the first passive equipment power source 121 and the second passive equipment power source 122, the determining may be configured to be based on the estimated cost of the power, and the estimated load at the power source during the time period.

The first node 101 is also configured to, e.g. by means of a providing unit 1103 within the first node 101 configured to, provide the first indication configured to indicate the source of power configured to be determined to at least one of the network node 110 and the second node 102 configured to operate in the communications system 100.

In some embodiments wherein the information configured to be obtained may be configured to comprise the first information on the respective temperature at the first passive equipment power source 121 and the second passive equipment power source 122, the first node 101 may be also configured to, e.g. by means of the determining unit 1102 within the first node 101 configured to, determine, using the first information configured to be obtained, the first temperature at the first passive equipment power source 121 at the future time period and the second temperature at the second passive equipment power source 122 at the future time period. The estimated cost of the power may be configured to be based on the first temperature configured to be determined and the second temperature configured to be determined.

In some embodiments wherein the information configured to be obtained may be configured to comprise the second information on the energy consumption at the network node 110, the first node 101 may be also configured to, e.g. by means of the determining unit 1102 within the first node 101 configured to, determine, using the second information configured to be obtained, the first load for the first passive equipment power source 121 at the future time period and the second load for the second passive equipment power source 122 at the future time period.

In some embodiments wherein the information configured to be obtained may be configured to comprise the second information on the energy consumption at the network node 110, the first node 101 may be also configured to, e.g. by means of the determining unit 1102 within the first node 101 configured to, determine the first cost of power of the first load configured to be determined at the first passive equipment power source 121 at the future time period and the second cost of power of the second load configured to be determined at the second passive equipment power source 122 at the future time period. The determining of the source of power to be used by the network node 110 at the future time period may be configured to be based on the first load configured to be determined and the second load configured to be determined.

The first node 101 may also be configured to, e.g. by means of a processing unit 1104 within the first node 101 configured to, process the information configured to be obtained to: a) synchronize the data from the first passive equipment power source 121, the second passive equipment power source 122 and the active power source 123 of the network node 110 and the site 120 where the network node 110 may be configured to be located, b) merge the synchronized data at the configured granularity to create the single source of data, and c) fill in the missing data with the average value configured to correspond to the time stamp of the missing value for a site 120 where the network node 110 may be configured to be located. The determining of the source of power to be used by the network node 110 at the future time period may be configured to be based on the information configured to be processed.

In some embodiments, at least one of the following may apply: a) the determining of the first cost may be configured to be further based on the first cost of maintenance of the first passive equipment power source 121 at the future time period, b) the determining of the first cost may be configured to be further based on the cost of charging the battery, and c) the determining of the second cost may be configured to be further based on at least one of: the state of charge of the battery, the aging of the battery, the temperature, the depth of discharge, and the source of recharge of the battery.

In some embodiments, the first node 101 may be further configured to repeat the actions it may be configured to perform, as described in the preceding paragraphs, periodically.

In some embodiments, the first node 101 may be configured to perform the actions it may be configured to perform, as described in the preceding paragraphs, in real time.

In some embodiments, the determining of the source of power to be used by the network node 110 at the future time period may be configured to be triggered by the outage of the active power source 123 at the network node 110.

In some embodiments, the information configured to be obtained may be configured to comprise data on the key performance indicators of the network node 110.

The embodiments herein may be implemented through one or more processors, such as a processor 1105 in the first node 101 depicted in FIG. 11, together with computer program code for performing the functions and actions of the embodiments herein. The program code mentioned above may also be provided as a computer program product, for instance in the form of a data carrier carrying computer program code for performing the embodiments herein when being loaded into the in the first node 101. One such carrier may be in the form of a CD ROM disc. It is however feasible with other data carriers such as a memory stick. The computer program code may furthermore be provided as pure program code on a server and downloaded to the first node 101.

The first node 101 may further comprise a memory 1106 comprising one or more memory units. The memory 1106 is arranged to be used to store obtained information, store data, configurations, schedulings, and applications etc. to perform the methods herein when being executed in the first node 101.

In some embodiments, the first node 101 may receive information from, e.g., the network node 110, the first passive equipment power source 121, the second passive equipment power source 122, the active power source 123, the one or more first sensors 131, the one or more second sensors 132, the site 120, the device 130, the second node 102 and/or another node, through a receiving port 1107. In some examples, the receiving port 1107 may be, for example, connected to one or more antennas in the first node 101. In other embodiments, the first node 101 may receive information from another structure in the communications system 100 through the receiving port 1107. Since the receiving port 1107 may be in communication with the processor 1105, the receiving port 1107 may then send the received information to the processor 1105. The receiving port 1107 may also be configured to receive other information.

The processor 1105 in the first node 101 may be further configured to transmit or send information to e.g., the network node 110, the first passive equipment power source 121, the second passive equipment power source 122, the active power source 123, the one or more first sensors 131, the one or more second sensors 132, the site 120, the device 130, the second node 102, another node, and/or another structure in the communications system 100, through a sending port 1108, which may be in communication with the processor 1105, and the memory 1106.

Those skilled in the art will also appreciate that the units 1101-1104 described above may refer to a combination of analog and digital circuits, and/or one or more processors configured with software and/or firmware, e.g., stored in memory, that, when executed by the one or more processors such as the processor 1105, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The units 1101-1104 described above may be the processor 1105 of the first node 101, or an application running on such processor.

Thus, the methods according to the embodiments described herein for the first node 101 may be respectively implemented by means of a computer program 1109 product, comprising instructions, i.e., software code portions, which, when executed on at least one processor 1105, cause the at least one processor 1105 to carry out the actions described herein, as performed by the first node 101. The computer program 1109 product may be stored on a computer-readable storage medium 1111. The computer-readable storage medium 1111, having stored thereon the computer program 1109, may comprise instructions which, when executed on at least one processor 1105, cause the at least one processor 1105 to carry out the actions described herein, as performed by the first node 101. In some embodiments, the computer-readable storage medium 1111 may be a non-transitory computer-readable storage medium, such as a CD ROM disc, a memory stick, or stored in the cloud space. In other embodiments, the computer program 1109 product may be stored on a carrier containing the computer program, wherein the carrier is one of an electronic signal, optical signal, radio signal, or the computer-readable storage medium 1111, as described above.

The first node 101 may comprise an interface unit to facilitate communications between the first node 101 and other nodes or devices, e.g., the network node 110, the first passive equipment power source 121, the second passive equipment power source 122, the active power source 123, the one or more first sensors 131, the one or more second sensors 132, the site 120, the device 130, the second node 102, another node, and/or another structure in the communications system 100. In some particular examples, the interface may, for example, include a transceiver configured to transmit and receive radio signals over an air interface in accordance with a suitable standard.

In other embodiments, the first node 101 may comprise the following arrangement depicted in FIG. 11b. The first node 101 may comprise a processing circuitry 1105, e.g., one or more processors such as the processor 1105, in the first node 101 and the memory 1106. The first node 101 may also comprise a radio circuitry 1111, which may comprise e.g., the receiving port 1107 and the sending port 1108. The processing circuitry 1105 may be configured to, or operable to, perform the method actions according to FIG. 3, and/or FIGS. 4-10, in a similar manner as that described in relation to FIG. 11a. The radio circuitry 1111 may be configured to set up and maintain at least a wireless connection with the network node 110, the first passive equipment power source 121, the second passive equipment power source 122, the active power source 123, the one or more first sensors 131, the one or more second sensors 132, the site 120, the device 130, the second node 102, another node, and/or another structure in the communications system 100.

Hence, embodiments herein also relate to the first node 101 operative for determining a source of power, the first node 101 being operative to operate in the communications system 100. The first node 101 may comprise the processing circuitry 1105 and the memory 1106, said memory 1106 containing instructions executable by said processing circuitry 1105, whereby the first node 101 is further operative to perform the actions described herein in relation to the first node 101, e.g., in FIG. 3, and/or FIGS. 4-10.

When using the word “comprise” or “comprising”, it shall be interpreted as non-limiting, i.e. meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

As used herein, the expression “based on” may be understood as “using”, e.g., for a determination or calculation, or “considering” or “factoring in”.

### References

1. U.S. Pat. No. 8,183,844B2.
2. U.S. Pat. No. 7,146,256B2.
3. U.S. Pat. No. 7,582,987B2.
4. US20150357864A1.
5. US20160087426A1.
6. U.S. Pat. No. 9,979,198B2.
7. Klemm C. et. Al. (2021) “Modeling and optimization of multi-energy systems in mixed-use districts: A review of existing methods and approaches”, Renewable and Sustainable Energy Reviews, vol. 135, January 2021.
8. Tang Q. et. Al. (2016) “Optimal Operation Method for Microgrid with wind/PV/diesel generator/battery and desalination”, Computational Science in Smart Grids and Energy Systems, vol. 2014, Article ID 857541.
9. Sufyan M. et. Al. (2019) “Optimal sizing and energy scheduling of isolated microgrid considering the battery lifetime degradation”, PLOS ONE.
10. Giannoutsos, S. V. et. Al. (2013) “Development of an integrated energy efficiency control system for ship power balance and diesel generator fuel consumption optimization”, 2013 IEEE Industry Applications Society Annual Meeting, 2013, pp. 1-11.

1. A computer-implemented method, performed by a first node, the method being for determining a source of power, the first node operating in a communications system, the method comprising:
obtaining information about a first passive equipment power source, a second passive equipment power source and an active power source of a network node,
determining, using machine learning and the obtained information, a source of power to be used by the network node at a future time period, out of the first passive equipment power source and the second passive equipment power source, the determining being based on an estimated cost of the power, and an estimated load at the power source during the time period, and,
providing a first indication indicating the determined source of power to at least one of the network node and a second node operating in the communications system.

2. The method of claim 1, wherein the obtained information comprises first information on a respective temperature at the first passive equipment power source and the second passive equipment power source, and wherein the method further comprises:
determining, using the obtained first information, a first temperature at the first passive equipment power source at the future time period and a second temperature at the second passive equipment power source at the future time period, and wherein the estimated cost of the power is based on the determined first temperature and the determined second temperature.

3. The method of claim 1, wherein the obtained information comprises second information on energy consumption at the network node, and wherein the method further comprises:
determining, using obtained second information, a first load for the first passive equipment power source at the future time period and a second load for the second passive equipment power source at the future time period, and
determining a first cost of power of the determined first load at the first passive equipment power source at the future time period and a second cost of power of the determined second load at the second passive equipment power source at the future time period, and wherein the determining of the source of power to be used by the network node at the future time period is based on the determined first load and the determined second load.

4. The method of claim 1, further comprising:
processing the obtained information to:
i. synchronize data from the first passive equipment power source, the second passive equipment power source, and the active power source of a network node and the site where the network node is located,
ii. merge the synchronized data at a configured granularity to create a single source of data, and
iii. fill in missing data with an average value corresponding to a time stamp of a missing value for a site where the network node is located,
wherein the determining of the source of power to be used by the network node at the future time period is based on the processed information.

5. The method of claim 1, wherein the first passive equipment power source is a diesel generator and the second passive equipment power source is a battery.

6. The method of claim 5, wherein at least one of:
a. the determining of the first cost is further based on a first cost of maintenance of the first passive equipment power source at the future time period,
b. the determining of the first cost is further based on a cost of charging the battery, and
c. the determining of the second cost is further based on at least one of: state of charge of the battery, aging of the battery, temperature, depth of discharge, and source of recharge of the battery.

7. The method of claim 1, further comprising: repeating the method periodically.

8. The method of claim 1, wherein the method is performed in real time.

9. The method of claim 1, wherein the determining of the source of power to be used by the network node at the future time period is triggered by an outage of the active power source at the network node.

10. The method of claim 1, wherein the obtained information comprises data on key performance indicators of the network node.

11. (canceled)

12. A computer program product comprising a non-transitory computer readable storage medium storing instructions which, when executed on at least one processor of a first node operating in a communication system, cause the at least one processor to perform a process that comprises:
obtaining information about a first passive equipment power source, a second passive equipment power source and an active power source of a network node,
determining, using machine learning and the obtained information, a source of power to be used by the network node at a future time period, out of the first passive equipment power source and the second passive equipment power source, the determining being based on an estimated cost of the power, and an estimated load at the power source during the time period, and,
providing a first indication indicating the determined source of power to at least one of the network node and a second node operating in the communications system.

13. A first node, for determining a source of power, the first node being configured to operate in a communications system, the first node being further configured to:
obtain information about a first passive equipment power source, a second passive equipment power source and an active power source of a network node,
determine, using machine learning and the information configured to be obtained, a source of power to be used by the network node at a future time period, out of the first passive equipment power source and the second passive equipment power source, the determining being configured to be based on an estimated cost of the power, and an estimated load at the power source during the time period, and,
provide a first indication configured to indicate the source of power configured to be determined to at least one of the network node and a second node configured to operate in the communications system.

14. The first node of claim 13, wherein the information configured to be obtained is configured to comprise first information on a respective temperature at the first passive equipment power source and the second passive equipment power source, and wherein the first node is further configured to:
determine, using the first information configured to be obtained, a first temperature at the first passive equipment power source at the future time period and a second temperature at the second passive equipment power source at the future time period, and wherein the estimated cost of the power is configured to be based on the first temperature configured to be determined and the second temperature configured to be determined.

15. The first node of claim 13, wherein the information configured to be obtained is configured to comprise second information on energy consumption at the network node, and wherein the first node is further configured to:
determine, using the second information configured to be obtained, a first load for the first passive equipment power source at the future time period and a second load for the second passive equipment power source at the future time period, and
determine a first cost of power of the first load configured to be determined at the first passive equipment power source at the future time period and a second cost of power of the second load configured to be determined at the second passive equipment power source at the future time period, and wherein the determining of the source of power to be used by the network node at the future time period is configured to be based on the first load configured to be determined and the second load configured to be determined.

16. The first node of claim 13, being further configured to:
process the information configured to be obtained to:
i. synchronize data from the first passive equipment power source, the second passive equipment power source and the active power source of the network node and the site where the network node is configured to be located, and
ii. merge the synchronized data at a configured granularity to create a single source of data, and
iii. fill in missing data with an average value configured to correspond to a time stamp of a missing value for a site where the network node is configured to be located,
wherein the determining of the source of power to be used by the network node at the future time period is configured to be based on the information configured to be processed.

17. The first node of claim 13, wherein the first passive equipment power source is configured to be a diesel generator and the second passive equipment power source is configured to be a battery.

18. The first node of claim 17, wherein at least one of:
a. the determining of the first cost is configured to be further based on a first cost of maintenance of the first passive equipment power source at the future time period,
b. the determining of the first cost is configured to be further based on a cost of charging the battery, and
c. the determining of the second cost is configured to be further based on at least one of: state of charge of the battery, aging of the battery, temperature, depth of discharge, and source of recharge of the battery.

19-20. (canceled)

21. The first node of claim 13, wherein the determining of the source of power to be used by the network node at the future time period is configured to be triggered by an outage of the active power source at the network node.

22. The first node of claim 13, wherein the information configured to be obtained is configured to comprise data on key performance indicators of the network node.
